(19) United States
(12) Patent Application Publication
(10) Pub. No.: US 2013/0166340 A1
(43) Pub. Date: Jun. 27, 2013

(54) System and Method for Online Marketing of Services

(71) Applicant: Mansour Anthony Salamé, Atherton, CA (US)

(72) Inventor: Mansour Anthony Salamé, Atherton, CA (US)

(21) Appl. No.: 13/334,010

(22) Filed: Dec. 21, 2011

(51) Int. Cl. G06Q 30/00; G06Q 10/06; G06Q 30/08

(52) U.S. Cl. 705/7.14; 705/26.1; 705/26.3; 705/26.2; 705/7.39

(57) ABSTRACT

A system for operating a marketplace for provision of services requiring skill, comprising a plurality of servers coupled to a data network, a registration software module deployed on at least one of the servers and adapted to enable the registration of a plurality of skilled workers, a worker skills management software module deployed on at least one of the servers and adapted to measure or manage skill levels of workers, and a contract management software module deployed on at least one of the servers. According to the embodiment, the contract management software module matches a buyer and a skilled worker based at least on the skilled worker's possessing a required skill and on the price satisfying rules established for the buyer and for the skilled worker.

### CROSS-REFERENCE TO RELATED APPLICATIONS

None.

### BACKGROUND OF THE INVENTION

1. Field of the Invention

The invention relates to the field of electronic commerce, and more particularly to the field of electronic marketplaces for the sale of services.

2. Discussion of the State of the Art

The market for services is one of the largest components of developed economies, encompassing everything from high-end professional services such as medical and legal services to low-wage services such as fast food attendants. A significant fraction of the services market is devoted to what have come to be known as “knowledge workers”. While these include doctors, lawyers, accountants, architects, and members of other recognized professions, it also includes many specialist worker categories that are not as well known, or at least as thoroughly professionalized. Examples include insurance claims adjusters, editors, translators, and the like.

A very significant number of people work in a recently developed service sector originally known as “call centers” but often referred to now alternatively as “contact centers”. While the boundaries of this sector are unclear (many people work in informal call centers such as appointment desks in hospitals, which often are not considered or counted as call centers at all), it is nevertheless clear that at least two million, and perhaps as many as four million, people work in contact centers in the United States alone (probably two or three times more in the rest of the world). Contact centers have, from their inception in the years following 1970, had difficulty managing their businesses, for two main reasons. The first is that the volume of incoming calls arriving at any given point of time varies greatly through a typical day in the life of a contact center, creating a challenging scheduling problem. If too few customer service representatives (“agents”) are available for a given volume of calls, callers are forced to wait for long periods before being answered (and they often hang up before being answered, effectively “abandoning” the call and potentially costing the call center a lost customer, or at least an unhappy one); on the other hand, if too many agents are on available, operating costs are much higher than needed. The second reason for difficulty in delivering service via contact centers is that it is very difficult to measure and manage service quality. Early call centers used a simple metric called “service level” to measure quality (service level is generally defined as the percentage of calls answered within some specific time, typically 20 seconds). But service level only measures how successful the center is in solving the staffing problem described above. It does not measure the quality of service delivered once an agent is connected with a calling customer.

These two perennial problems have led to the emergence of several important technology elements that today are present in virtually all large (and many small) contact centers. One of these technologies, workforce management (“WFM”), has focused on solving the scheduling problem. WFM systems generally feature a forecasting element, which creates a set of forecasts of future call volumes (one forecast for each distinct call type). These forecasts are then used by a scheduling engine that takes into account work rules (for breaks, meals, and so forth), and vacation needs, and attempts to create an optimal schedule for some period of time. “Optimal” means that in theory all calls would be answered within a specified time limit (generally the same limit used to compute service level), with no “extra” agents on staff. WFM systems also typically include real-time adherence modules that measure adherence, by the agents, to a published schedule (this is generally considered important, since any deviation from the schedule can cause a mismatch in the population of agents relative to the volume of calls). Another major technology that emerged, like WFM, in the late 1980s is large-scale automated call recording. Using technology originally designed for law enforcement and national security wiretapping needs, call recording systems typically record all or most of the calls arriving at (or originating at; outbound calling is another major area of contact center activity). Call recording is performed for several reasons, including non-repudiation in disputed situations, legal records in areas such as securities sales where every call must be recorded, or quality assurance. This last need—quality assurance—not only uses call recording technology, but also provides for eavesdropping on calls in progress by supervisors and full-time “quality monitors”, and indeed a separate quality monitoring software application category has emerged as well to provide for the needs of those monitoring customer calls, either in real time or from recordings. Finally, call routing (choosing from among a variety of available “targets” to which to deliver an inbound call, generally based on a variety of algorithms) has emerged as an important technology element in contact centers.

These technologies—WFM, call recording, quality monitoring, call routing, and indeed others—have in turn led to the emergence of wholly new types of expert workers. Forty years ago, there was no need for people who were specialized in forecasting call arrival rates and generating optimum schedules, because call centers had just started and there was no equivalent job category elsewhere. Similarly, as quality monitoring matured, what once was merely a job for supervisors to do using “common sense” developed into a separate job category (“quality monitor”), and “call routing expert” has become a specialized form of technical worker—not quite a software developer, but more than a mere switch technician. Similar new categories of jobs have emerged in other industries as well, and often represent real challenges where matching supply of skilled workers in these new categories to demand for their services.

The emergence of several new “knowledge worker” job categories in contact centers has led to two new problems. On the one hand, in large contact centers where several of each of these new worker types would typically be employed, a challenge is that the workers are only able to develop their skills in contact with a single company's challenges. In the case of complex areas such as forecasting, expertise is much better developed in contact with a wide range of problems of differing natures to solve, rather than repeatedly solving more or less the same problem. Exposing experts to only small, repetitive problem spaces will tend to hamper their development as experts and also to lead to high turnover of the best experts (who typically will pursue their professional development directly by leaving for new challenges). On the other hand, in smaller contact centers it is often not possible to maintain a staff of experts in all of the areas such as forecasting, quality monitoring, routing (and indeed voice application development, operational data analysis, report development, and so forth). Smaller contact centers often operate without the benefit of techniques and technologies that are commonplace in larger contact centers because they cannot amortize the high cost of such people and systems across large agent populations (since they only have few agents).

It would be desirable for newer expert categories such as forecasting, quality monitoring, routing, and the like to be accessible in a way similar to older professions such as legal practice. Large multinationals, which will typically have in-house teams of lawyers of most types, still turn to large law firms for outside counsel work. They seek the benefit of attorneys who have been able to learn by working on a wide variety of problems within their specialty—typically more experience and more variety than an in-house lawyer would be able to accumulate. Moreover, outside counsel are able to focus exclusively on the practice of law in their specialty areas, and will normally be much more up-to-date on new developments and infrequently encountered problems and techniques; in house counsel often have additional duties that detract from their ability to focus on “the practice of law”. Smaller companies typically will have either no lawyers on staff at all, or they might have a general counsel and one or two contracts attorneys; they tend to rely on law firms to meet all of their other legal needs. These firms do not have the scale to maintain teams of litigators, for example, but when litigation arises they need immediate access to well-qualified litigators. They expect, and get, litigators who have spent years doing nothing but litigation precisely because there is a thriving and ancient market in legal services that has evolved with society to be able to meet the needs of companies of all sizes readily.

There are many other new service professional categories besides these within the contact center industry, and indeed there are even more in the economy as a whole. In addition, in some cases existing professional categories, such as editor, which previously were closely tied to a place and an employer (editors worked in the offices of publishers), are no longer so tied, and their work is now often performed by highly qualified professionals working from home offices, whether for one employer or for several. It is expected that, as communications and computing capabilities available to individuals continue to explode, experts of many types will migrate away from traditional full-time employment roles to roles that follow a model similar to that of the law profession (where something like 70% of all lawyers work in private practice serving many clients).

To make it possible for these problems to be solved, what is needed is a online marketplace that enables skilled workers (as opposed to undifferentiated commodity laborers) to market themselves, win and serve clients, and compete with others, in a global marketplace from wherever they choose to live and work.

### SUMMARY OF THE INVENTION

Accordingly, in a preferred embodiment of the invention provides a system for operating a marketplace for provision of services requiring skill, comprising a plurality of servers coupled to a data network, a registration software module deployed on at least one of the servers and adapted to enable the registration of a plurality of skilled workers, a worker skills management software module deployed on at least one of the servers and adapted to measure or manage skill levels of workers, a pricing software module deployed on at least one of the servers, and a contract management software module deployed on at least one of the servers. According to the embodiment, the pricing software module determines a price for a unit of work the performance of which requires at least one specific skill managed by the worker skills management software module, and the contract management software module matches a buyer and a skilled worker based at least on the skilled worker's possessing a required skill and on the price satisfying rules established for the buyer and for the skilled worker.

In another embodiment of the invention, upon registration a skilled worker establishes a set of rules specifying at least a price constraint for use in assigning work to the skilled worker. In a further embodiment, the invention further comprises a correlation engine software module deployed on at least one of the servers. In another embodiment, the correlation engine is used to evaluate tuples relating to a set of skilled workers, each tuple comprising at least two or more of pricing rules, skill levels, and schedule constraints of a particular skilled worker, in order thereby to select a specific set of skilled workers to perform a specific set of work tasks. In yet another embodiment, the skills management software module automatically determines a skill level of a skilled worker. In another embodiment, the automatic determination of a skill level is carried out using the correlation engine. In yet another embodiment, the price is a fixed bid price established by a prospective buyer of services. In yet a further embodiment, the price is determined by a formula dependent on at least two of service quality, service timing, and service quantity delivered by a specific plurality of workers.

According to another preferred embodiment of the invention, a method of providing marketplace services to facilitate transactions involving delivery of services requiring skill is disclosed. According to the embodiment, the method comprises the steps of: (a) registering a plurality of skilled workers; (b) determining at least a skill level for each of the plurality of skilled workers; (c) establishing a price for a unit of work the performance of which requires at least one specific skill; (d) matching a buyer and a skilled worker based at least on the skilled worker's possessing a required skill and on the price satisfying rules established for the buyer and for the skilled worker; and (e) generating and publishing a binding contract for delivery services to a specific buyer by a specific skilled worker.

In another embodiment of the invention, the method further comprises the step of monitoring performance of the services specified by the binding contract to determine at least a quality score for the services performed. In yet another embodiment of the invention, the method further comprises adjusting the contracted price based on the quality score.

### BRIEF DESCRIPTION OF THE DRAWING FIGURES

Various embodiments of the invention will now be described in detail by way of example only with reference to the following drawings:

FIG. 1 is a diagram showing various participants in an expertise marketplace and their interrelationships, according to a preferred embodiment of the invention.

FIG. 2 is a block diagram of a system for providing an expertise marketplace according to a preferred embodiment of the invention.

FIG. 3 is a block diagram of an embodiment of the invention illustrating a marketplace for workforce management and quality management service delivery for contact centers.

FIG. 4 is a process flow diagram illustrating a method for establishing and managing a pool of experts, according to an embodiment of the invention.

FIG. 5 is a process flow diagram illustrating method for establishing work contracts, according to an embodiment of the invention.

FIG. 6 is a process flow diagram illustrating a method for implementing a dynamic pricing model for an expertise marketplace, according to an embodiment of the invention.

FIG. 7 is a process flow diagram illustrating a scheduling availability of experts and delivery of work suitable for execution by the experts, according to an embodiment of the invention.

### DETAILED DESCRIPTION

The inventor has conceived, and reduced to practice, a system and methods for online marketing of skilled services (or an “expertise marketplace”) that addresses the challenges and problems in the art outlined above.

In the description below, many references will be made to “databases” and “data storage subsystems” used for various purposes in various embodiments of the invention. These terms should be treated as synonymous, and refer to systems adapted for the long-term storage, indexing, and retrieval of data, the retrieval typically being via some sort of querying language. “Database” can refer to relational database management systems known in the art, but should not be considered to be limited to such systems. Many alternative database or data storage system technologies have been, and indeed are being, introduced in the art, including but not limited to distributed non-relational data storage systems such as Hadoop, column-oriented databases, and the like. While various embodiments may preferentially employ one or another of the various data storage subsystems available in the art (or available in the future), the invention should not be construed to be so limited, as any data storage architecture may be used according to the embodiments. Similarly, while in some cases one or more particular data storage needs are described as being satisfied by separate components (for example, a workforce management database and a call recording database), these descriptions refer to functional uses of data storage systems and do not refer to their physical architecture. For instance, any group of data storage systems of databases referred to herein may be included together in a single database management system operating on a single machine, or they may be included in a single database management system operating on a cluster of machines as is known in the art. Similarly, any single database (such as WFM database) may be implemented on a single machine, on a set of machines using clustering technology, on several machines connected by one or more messaging systems known in the art, or in a master/slave arrangement common in the art. These examples should make clear that no particular architectural approaches to database management is preferred according to the invention, and choice of data storage technology is at the discretion of each implementer, without departing from the scope of the invention as claimed.

Similarly, preferred embodiments of the invention are described in terms of a web-based implementation, including components such as web servers 221 and web application servers 220. However, these components are merely exemplary of a means for providing services over a large-scale public data network such as Internet 101, and other implementation choices could be made without departing from the scope of the invention. For instance, while embodiments described herein deliver their services using web services accessed via one or more webs servers 221 which in turn interact with one or more applications hosted on application servers 220, other approaches such as peer-to-peer networking, direct client-server integration using Internet 101 as a communication means between clients and servers, or use of mobile applications interacting over a mobile data network with a one or more dedicated servers are all possible within the scope of the invention. Accordingly, all references to web services, web servers 221, application servers 220, and Internet 101 should be taken as exemplary rather than limiting, as the inventive concept is not tied to these particular implementation choices.

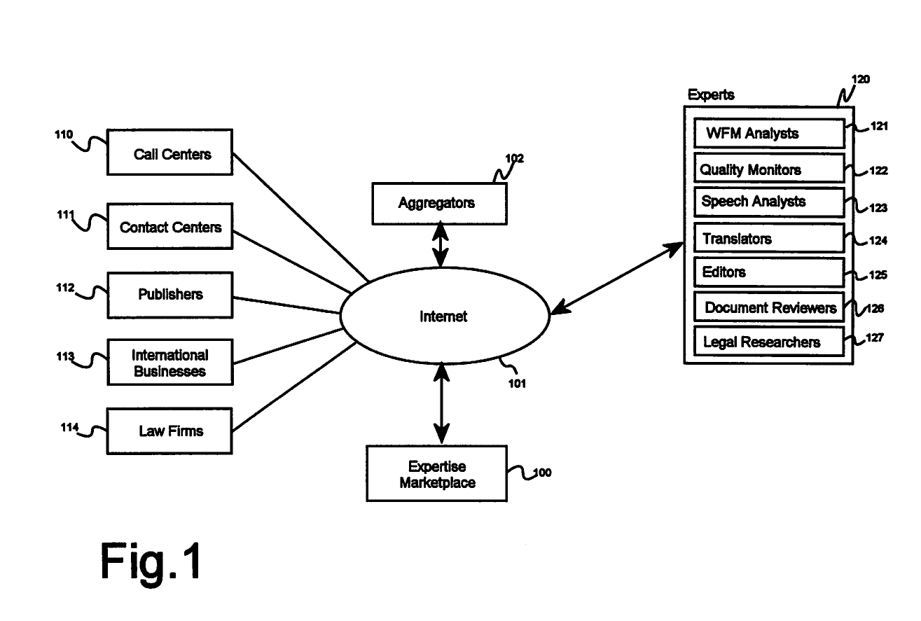

FIG. 1 provides a high-level overview of typical parties involved in delivering and using an expertise marketplace according to a preferred embodiment of the invention, and of an exemplary set of relationships between the parties. As just mentioned, FIG. 1 illustrates an exemplary approach in which communications between parties occurs substantially via Internet 101, but other communications means are envisioned by the inventor, including use of mobile data networks, private networks, and the like. According to the embodiment, expertise marketplace 100 provides a means for entities in need of the services of one or more experts may seek out such experts, advantageously contract for delivery of expert services, and fulfill their ends of such contracts. Similarly, experts are provided a means for making their services available to a wide range of potential buyers, to demonstrate and benefit from the quality of their services delivered, to enter into advantageous contracts with one or more buyers, and to fulfill those contracts.

Buyers of expert services using expertise marketplace 100 may include, but are not limited to, call centers 110, contact centers 111 (typically “contact center” refers to a call center that also handles other media interactions with customers, such as emails or chat sessions), publishers 112, international businesses 113, and law firms 114. Experts 120 may include, but are not limited to, WFM analysts 121, quality monitors 122, speech analysts 123, translators 124, editors 125, document reviewers 126, and legal researchers 127; it should be clear that these are merely exemplary kinds of experts who can provide service in conjunction with expertise marketplace 100, and that the invention is not limited to these in any way.

Uses of expertise marketplace 100 may be understood by considering one or more of the following exemplary use cases. In one embodiment, a plurality of call centers 110 and contact centers 111 use expertise marketplace 100 to contract for services from a plurality of WFM analysts 121, quality monitors 122, and speech analysts 123. WFM analysts 121 are used to analyze calling (or emailing, etc.) patterns in call centers 110 and contact centers 111, and to build, insofar as it is possible, accurate forecasts of future call or interaction (email, chat, etc.) volumes, in order to build up a forecast of demand for various agent skillsets required to adequately handle the expected call and interaction volumes. After building forecasts, WFM analysts then typically generate optimized schedules using data pertaining to the skills of potentially available agents at call centers 110 and contact centers 111, and publish these schedules for use in call centers 110 and contact centers 111. An important aspect of WFM analyst's work includes review of actual results, both in terms of adherence to published schedules by call center 110 or contact center 111 staff, and in terms of forecast accuracy. An expert WFM analyst is able to leverage lessons learned across multiple situations to become more proficient at generating accurate forecasts (which may for example need to take into account expected weather conditions, planned promotional activities for a product that will lead to additional calls, and other external factors that may drive call volume in a predictable way). In many ways WFM analysts are analogous to quantitative analysts on Wall Street—they use many well-established “tricks of the trade”, but they also continuously develop new proprietary approaches—and accordingly there is great benefit to an analyst's having access to data from many clients rather than from just one employer, as this exposes them to more opportunities to learn.

Similarly, another exemplary use case for expertise marketplace 100 is for publishers 112 to outsource routine editing to potentially large numbers of independent editors 125. Similarly, translators 124 could be hired via marketplace 100 to serve various needs of international businesses 113, and in another example law firms 114 could use contract attorneys as document reviewers 126 and other legal researchers 127 to perform routine legal research tasks at costs far lower than they would incur if they employed legal researchers 127 as full-time employees. Finally, in some cases one or more aggregators 102 may use expertise marketplace 100 to advantage by providing expert services to one or more buyers, each of whom would form a single contract defining price, timing, and quality parameters, with an aggregator 102 (rather than forming a large number of contracts with individual experts 120). In effect, aggregators 102 may operate a single-sided marketplace of their own, selling services directly to one or more companies on terms of their choosing, and then providing marketplace services to experts 120 to allow each of them to compete to win a share of services sold by aggregator 102. For instance, aggregator 102 may propose to a contact center operator that “we will perform customer satisfaction surveys on 30% of your inbound calls, each survey being completed within one hour of the call to which it refers, for a flat rate of one dollar per call”, significantly underbidding her competition. If the company accepts the offer, aggregator 102 carries risks associated with non-delivery or poor quality, but if successful in engaging a market of experts will be able to capture most of the profits generated. In some embodiments, an aggregator 102 might be, for example, a quality monitoring service provider that sells and delivers quality monitoring services at competitive prices while meeting stipulated performance measures—and aggregator's 102 clients will generally not know whether such services are provided by employees of aggregator 102 or by contractors who competitively bid to deliver the services using aggregator's 102 marketplace for experts.

It will be appreciated that each of the exemplary uses just described will depend in a fundamental way on the existence of well-understood pricing, scheduling, work management, and quality assurance functions. Buyers will not engage in contracting with potentially anonymous experts 200 if they cannot be confident that agreed prices are honored, that schedules are met, and that work quality meets any agreed standards. Thus major aspects of each embodiment of the invention include means for providing offering—and enforcing—various pricing mechanisms, work management and scheduling features, and quality assurance capabilities. In some embodiments, such needs may be met by market makers 103 (that may also act as aggregators 102 or as members of marketplace 100) that perform a role analogous to that provided by market makers in securities marketplaces such as stock exchanges. In some cases, expertise marketplace 100 may employ or contract with one or more market makers 103 to help ensure orderly market functioning (for instance, market maker 103 might commit itself to deliver certain services in order to ensure that marketplace 100 demonstrates adequate liquidity and stability); in return for taking on the risk of acting as a market maker 103, market makers 103 may receive a “spread” between a bid and an ask price, as is commonly done in securities markets. Generally market makers 103 will act as experts with regard to one or more classes of expert services sold through expertise marketplace 100, acting as a guarantor of service quality or integrity, and providing sufficient liquidity to allow marketplace 100 to operate efficiently. Market makers 103 and aggregators 102 may together or separately have a significant effect on prices within marketplace 100, for instance by setting de facto price standards such as “a five-star quality monitoring session is $10, but a three-star session is $2”. Also, in some cases market makers 103 will work to ensure that spreads between bid prices (from buyers) and ask prices (from sellers) do not diverge or grow arbitrarily large or volatile, for example by committing its own resources to contracts in order to maintain spreads within tolerable limits.

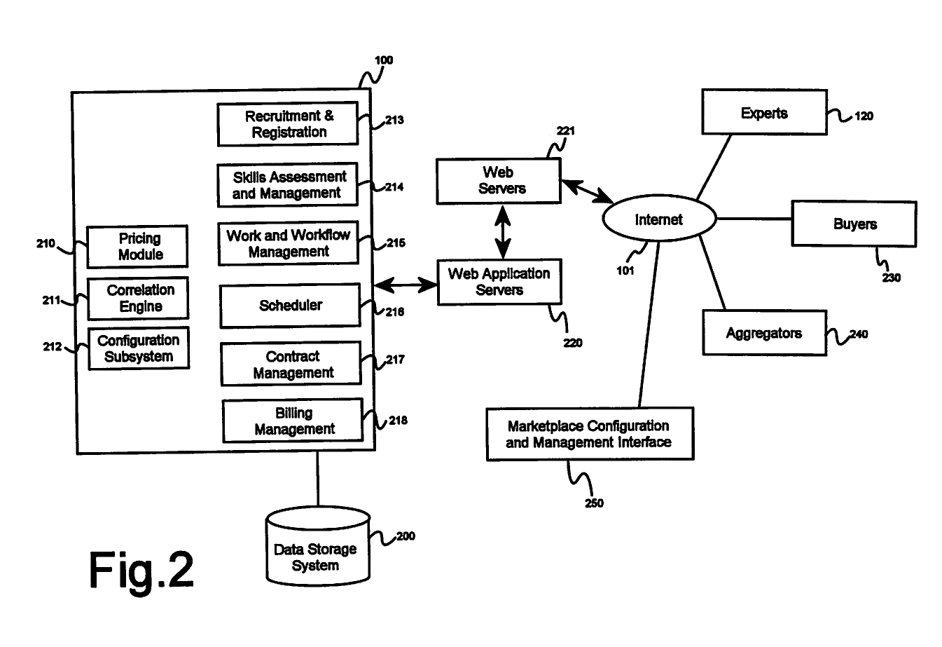

Components and services that make up online marketplaces for expert services will be discussed in more detail in relation to FIGS. 2-9.

FIG. 2 is a block diagram of a system for providing an expertise marketplace 100 according to a preferred embodiment of the invention. According to the embodiment, various components of expertise marketplace 100 are adapted to operate as web applications served by one or more web application servers 220. As mentioned above, this particular architectural approach is intended merely to illustrate aspects of the embodiment, and should not be taken to limit the invention to implementation using a web services-based architecture. Web application server (or simply “application server”) 220 may be of several types well known in the art, such as Apache Tomcat, Microsoft Windows™ Server with .NET Framework, JBoss, and the like. Typically, web application servers 220 are accessed by clients via web server 221, which may be Apache, Microsoft Internet Information Server (IIS), Sun's Java System Web Server, or any similar web server. Normally, clients (typically but not exclusively web browsers) send hypertext transfer protocol (HTTP) requests of various types to a web server 221. Web server 221, when it receives requests to server “simple” hypertext markup language (HTML) or other well-established markup languages that do not require separate processing (such as computations, access to databases, or use of software modules that are not part of web server 221), provides appropriate results directly to the requesting client without involvement of web application server 220. However, in many cases (such as a preferred embodiment of the instant invention), more functionality is needed to satisfy a client request than can be provided by web server 221; in these cases, it is common to use web applications hosted on web application server 220. When web server 221 receives a request that uses a web application, it passes the request to an appropriate web application server 220, which carries out the necessary software operations and returns any results generated, normally as HTML, to web server 221, which then “serves up” ordinary HTML to the requesting client for display to its user. “Web application” refers to a software application that is hosted by a web application server 220 and that interacts with its users over Internet 101 or any other data network through the services of web server 221.

According to a preferred embodiment of the invention, expertise marketplace 100 comprises a number of software applications or modules. In some embodiments, these modules interact with each other directly using any of the many interprocess communications techniques known in the art, while in others they are loosely coupled, interacting with each other through web server 221 and web application server 220 (that is, in some embodiments, each software module or application treats all the other applications as clients indistinguishable, architecturally, from the web browser clients used by experts 120, buyers 230, and aggregators 240. Similarly, while various software applications are shown as separate components in FIG. 2, in various embodiments software applications 210-218 are combined in different ways. For instance, in an embodiment at one extreme, all functions of expertise marketplace 100 operate on a single general purpose computer, indeed as a single executable program (in such an embodiment, separate components comprising expertise marketplace 100 can be considered as subroutines or internal modules of the one executable); in another embodiment at the opposite extreme, every software component 210-218 of expertise marketplace 100 may be a standalone web service operating in a distributed fashion, with full copies of each component's code resident on numerous general purpose computers operating either as a cluster or using one of various load balancing schemes known in the art. With these architectural variations available, it should be appreciated by one having ordinary skill in the art of web application programming that the components making up expertise marketplace 100 in FIG. 2 are shown separately, with each as a whole entity, in order to illustrate certain functional aspects of the embodiment clearly, and this arrangement should not be taken as limiting.

Web applications commonly rely on an underlying database to perform their tasks, and expertise marketplace 100 follows this pattern. Data storage system 200 is a repository for any and all persistent data generated or used by any of the software modules 210-218 in expertise module 100. Data storage system 200 can take any of many forms known in the art, including but not limited to relational database management systems such as Oracle of Microsoft SQL Server (resident on one computer or using a cluster of computers), scalable non-relational data storage systems such as Hadoop, or even flat files (again, whether operating on a single computer or using a distributed file management system). Some embodiments (those using relational databases) will use the well-established Structured Query Language to add, remove, change, and access data in data storage subsystem 200, while others will use other querying languages or capabilities such as XPath, Resource Description Framework (RDF), or even proprietary query interfaces (which is what all programs used prior to the emergence of database standards in the late 1970s). It should be understood by those having ordinary skill in the art of data systems design and programming that any system that provides a means for persistent storage of data from applications running across a network, and that allows access to that data under control of various well-known security processes (user-level access control, encrypted data transfers, masking of passwords and other sensitive data, and so forth), can be used as data storage system 200 without departing from the scope of the invention. The same comments apply to other database systems introduced herein—the various embodiments of the invention are not specific to any choice of data storage architecture or query language, and should not be so limited.

According to a preferred embodiment of the invention, users who are managers or employees of expertise marketplace 100 interact with marketplace 100 through marketplace configuration and management interface 250. In some embodiments, interface 250 will be a series of web pages served by web server 221 and accessed via any conventional web browser, while in other embodiments interface 250 may be a standalone “thick client” or “rich client”. It will be understood that there are many well-known conventions for providing interfaces between a human user and a specific software module or set of software modules, any of which may be adopted according to the invention, without limiting the scope of the invention.

As each of the various software applications that comprise an expertise marketplace 100 according to a preferred embodiment of the invention is discussed, it should be kept in mind that each can be implemented purely within a web scripting language such as Javascript, or may use advanced web technologies such as AJAX or HTML 5, or may be coded in any programming language (such as Java, C#, C++, C, PHP, Ruby, and the like), without limitation. Also, not all of the software modules need to be coded or implemented in the same language or using the same underlying technology. It is possible that each software module is coded using a different language or technology framework than all of the others. Also, while employees of marketplace 100 will typically interact, as described above, via marketplace configuration and management interface 250, in some embodiments individual software components 210-218 and 200 may have separate, component-specific user interfaces. These interfaces are not shown, as it should be understood by one having ordinary skill in the art of user interfaces that using separate tabs or menu options within marketplace configuration and management interface 250, or having separate standalone user interfaces, are merely different well-known ways to provide access to a variety of functional elements to individual users, and any such arrangements known in the art may be used without departing from the scope of the invention.

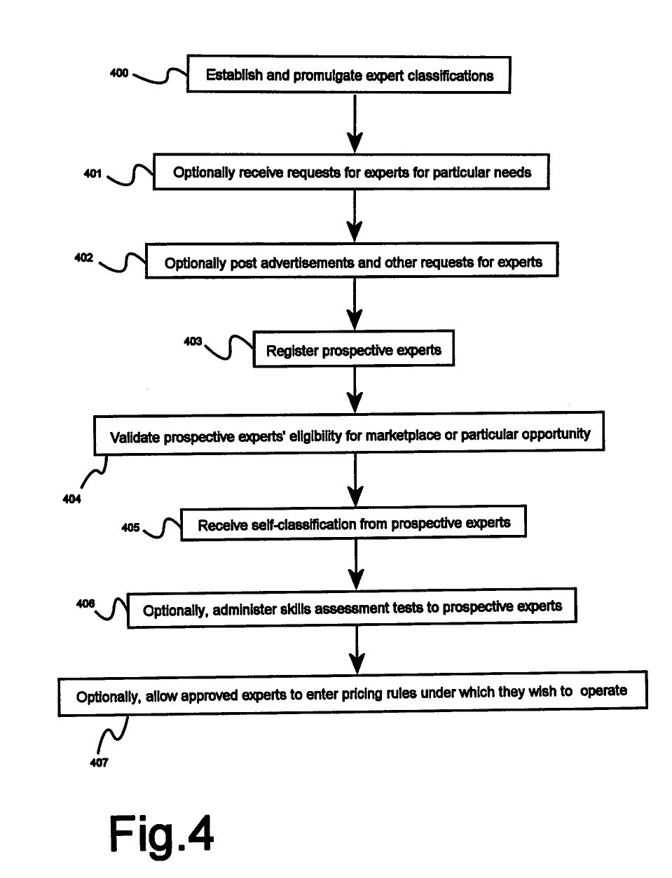

Recruitment and registration module 213 is a software application that allows expertise marketplace 100 to establish an inventory of experts 120 that may then be advantageously used to provide expert work to one or more buyers 230. By managing recruitment efforts, which will be discussed in detail with reference to FIG. 4, recruitment and registration module 213 generates a supply of potential experts 120 who are then given an opportunity to register with marketplace 100. Registration entails collection of data pertaining to a new expert, including such items as name, address, bank account data, user name, and so forth. Registration processes for web sites, particularly those involving ecommerce, are extremely well known in the art and any appropriate registration processes may be used according to the invention. In some embodiments recruitment and registration module 213 provides registering service providers or experts with user interface elements that allow them to enter self-assessed skill and certification data. For example, in an embodiment a registering contact center quality monitoring service provider might provide a set of data elements pertaining to industry standard qualifications and/or certifications that the provider has achieved, as well as a list of other skills the provider asserts she possesses. In some embodiments further skills are determined automatically as described with reference to skills assessment and management module 214; it will be appreciated by one having ordinary skill in the art that the “division of labor” between recruitment and registration module 213 and skills assessment and management module 214 may be combined in either or both of the modules, or provided in other ways; recruitment and registration module 213 and skills assessment and management module 214 are, like all of the software servers or modules described herein, described for exemplary purposes, and the invention should not be limited to any particular architecture shown or described.

Skills assessment and management module 214 conducts a variety of skills assessments (also described in detail with reference to FIG. 4), including a combination of self-assessments and automated skill assessments such as tests for particular skill elements, in order to create an initial skills profile for each newly registered expert 120. In addition, skills assessment and management module 214 may, in some embodiments, periodically analyze data captured during execution of expert work by experts 120 to further refine, and update, skill profiles. In some embodiments, skill assessments and measurement may be made by or in conjunction with correlation or optimization engine 211, since a correlation engine 211 may be required to assess a particular service provider's quality or skill level by comparing the provider's performance against a wide range of other service providers, generally using correlations of multiple quantitative measures, since such assessment might depend on determining various correlation relationships between potentially large numbers of measured variables. For example, when a contract for expert services is completed, skills module 214 may automatically send a quality assessment survey to the applicable buyer (or buyers), to gage the quality of the service delivered. Moreover, skills module 214 may in some embodiments measure objective criteria or metrics pertaining to delivery of expert services by experts 120 in order to validate or modify existing skill profiles. For example, skills module might measure forecast accuracy for a series of completed forecasts, once the periods for which the forecasts were generated have passed, by comparing forecasted values for parameters such as call arrival rates with actual values. Such automated measurement of metrics will often provide excellent measurement of one or more underlying skills (in this example, the skill of making accurate forecasts), and can also serve as an efficient method for measuring and managing quality of services delivered by experts using expertise marketplace 100.

Work and workflow management module 215 is a software module or application (with all of the flexible architectural possibilities discussed earlier) that manages the delivery, in real time, of work required by a plurality of service contracts to a population of experts 120. There are several important aspects to work management and workflow management that are carried our by work management module 215, one of which is routing of work items. In any given period, there will typically be some set of work items that are either required to be done in that period or that are in a backlog status and therefore are available to be performed at an opportune time. Similarly, in any given period some population of experts 120 will be available, either actively logged in and working, or determined to be available based on work availability rules set up by the experts (for example, a WFM specialist might specify, when registering or when later modifying her preferences, that she will generally be available on Wednesday afternoons). Some work items may be designated as time critical or synchronous with some related event, meaning that work must be done at a specific time or when a specific related event occurs. For example, it may be specified in a work contract that every call of a certain type for a particular contact center should be monitored by an available quality monitor as it occurs. For work items of this type, work management module 215 acts much like a call router in call centers, which are well known in the art, having to immediately select from among a population of available experts one to carry out the time-critical task. Work module 215 will in some embodiments directly interact with an expert's workstation to “push” a work item to the expert, whereas in other cases work will be designated to be performed by one or more specific experts and, when one of the designated experts requests a new work item from work management module 215, an appropriate work item is designated. In some cases there will be more than one work item available for accomplishment by a given expert when that expert becomes available or requests a work item; in such circumstances work management module 215 must select a particular work item from among those available for delivery to the specific expert.

In addition to managing the delivery of work items to experts as experts become available for more work, and routing synchronous work items proactively, work management module 215 also serves as a basic workflow engine for contracted services. In some cases a contract may specify a set of related tasks that must be performed in a certain order, or within some set of logical constraints (for example, within one day following a call monitoring session, a second quality monitoring expert should be assigned, in 20% of cases, to independently assess the quality of the monitored call by listening to a recording of the call). In such workflow-like situations, work management module 215 uses data storage system 200 to store persistent data about the states of each task that comprises each work flow, and periodically (or as required by events) retrieves from the database 200 appropriate work tasks to move the work flow forward. Workflow management systems are well established in the art, and any of the several types that are known in the art may be used as a component of work and workflow management module 215 without departing from the scope of the invention.

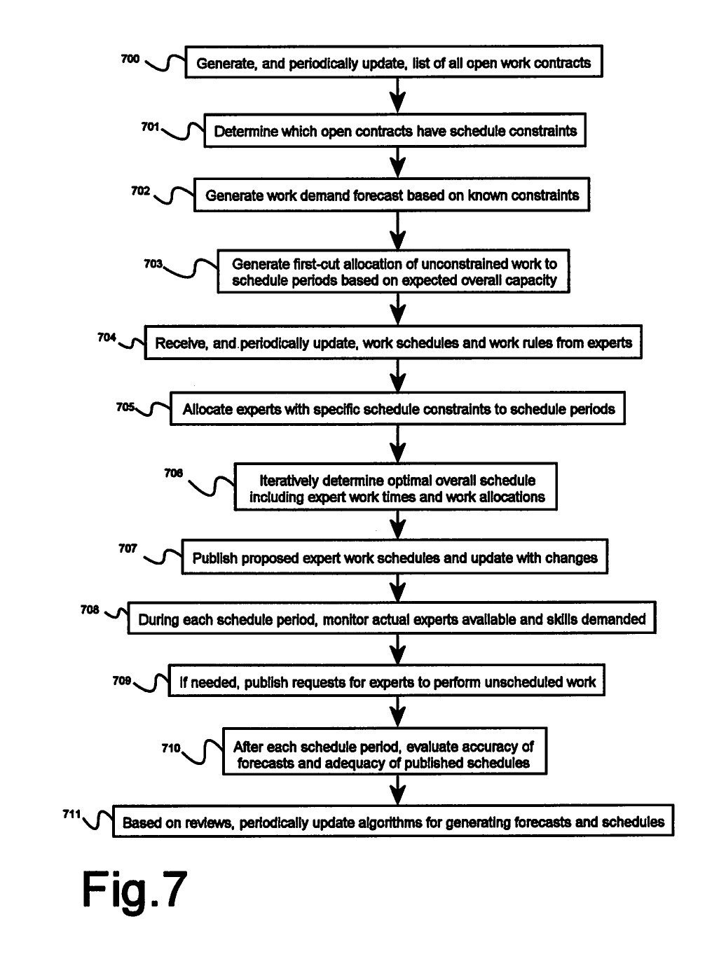

Scheduler 216 is a software application or module (with all of the flexible architectural possibilities discussed earlier) that carries out functions related to scheduling work that will need to be accomplished in specific period, and for creating and publishing work schedules for experts 120 who have agreed to have expertise marketplace 100 designate specific periods in which they will be provided work. A scheduling process according to a preferred embodiment of the invention will be discussed in detail with reference to FIG. 7.

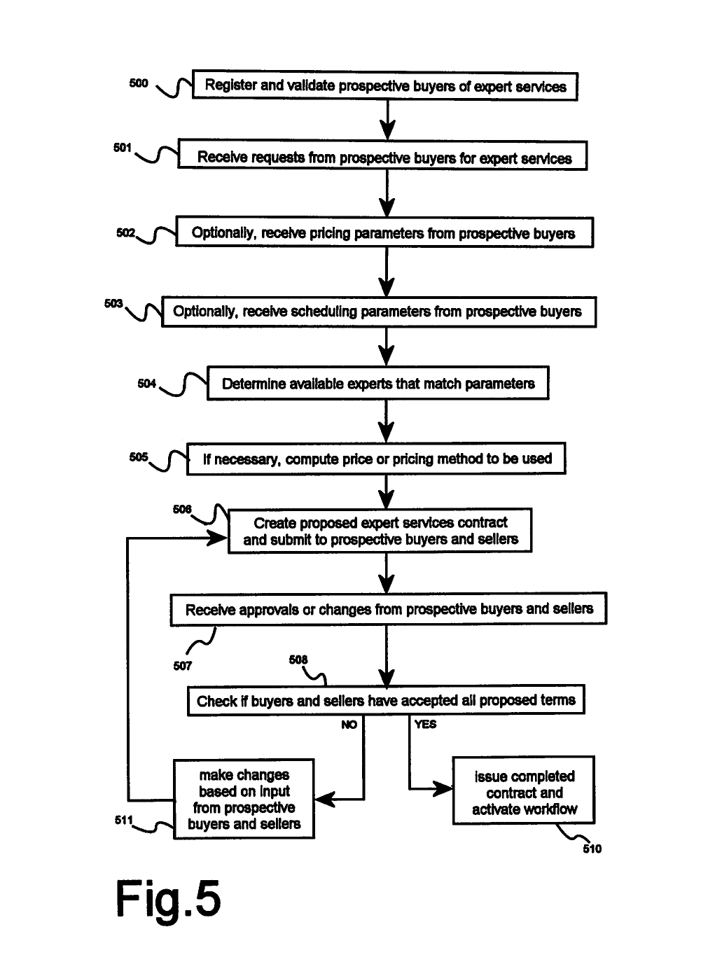

Contract management module 217 is a software application or module (with all of the flexible architectural possibilities discussed earlier) that manages the process of forming contracts between buyers 230 and experts 120. In a preferred embodiment, contract management module 217 matches one or more prospective buyers who seek to purchase a specific type of service (perhaps specified by a plurality of service attributes such as minimum skill level required in various skills, timeliness of service delivery, price, quality, and so forth) to one or more prospective buyers who seek to sell the requested service, or one that is similar enough to provide a satisfactory match for the prospective sellers' requirements. Once a satisfactory set of prospective buyers and sellers is determined through one of a variety of matching processes according to various embodiments, contract management module 217 may, for example, propose a transaction to the buyers and sellers. In other embodiments, contracts are generated automatically when contract management module 217 determines that an optimal or near-optimal matching of buyers and sellers has been achieved, and in such embodiments contract management module 217 automatically generates and delivers binding contracts to the parties. It will be appreciated by those having ordinary skill in the art of matching algorithms that there are any number of criteria that may be used by contract management module 217 to match sets of buyers and sellers, such matching techniques variously featuring mandatory, preferred, optional requirements of buyers or sellers (or both), as well as many possible mixes of binary, qualitative, and quantitative matching techniques, any of which may be used according to the invention. An exemplary process for establishing binding contracts is discussed in detail with reference to FIG. 5.

Billing management module 218 is a software application or module (with all of the flexible architectural possibilities discussed earlier) that manages the process of billing buyers 230 for completed work or closed contracts. Since many advanced billing systems exist in the art, any of which may be used according to the invention, a few points will be made about particular billing aspects characteristic to embodiments of expertise marketplaces 100 according to the invention. Each contract may contain specific requirements about the timing of billing, for example by requiring monthly bills for all work tasks accomplished, or by specifying that billing will be accomplished only after all tasks designated in a particular contract are completed. In some cases, contract rules may specify that billing for any given tasks (or any given sets or types of tasks) can only be conducted after the tasks have been reviewed or measured against quality standards and have been determined to have been satisfactory. And, in some cases particular pricing rules may be specified that, as will be discussed below, may depend on when or how particular services are delivered (and possibly also on by whom the services were delivered). It should be appreciated that there will be a wide variety of permutations of the various factors of timing, completion state, quality, quantity, price, and so forth that may determine exactly when and for how much various work tasks are to be billed; executing these logical permutations is a task of billing manager 218. Additionally, billing manager 218 may be responsible for actually collecting, using electronic means, payment for bills rendered; in some embodiments, though, separate payment systems including potentially payment systems operated by independent third parties may be used without departing from the scope of the invention.

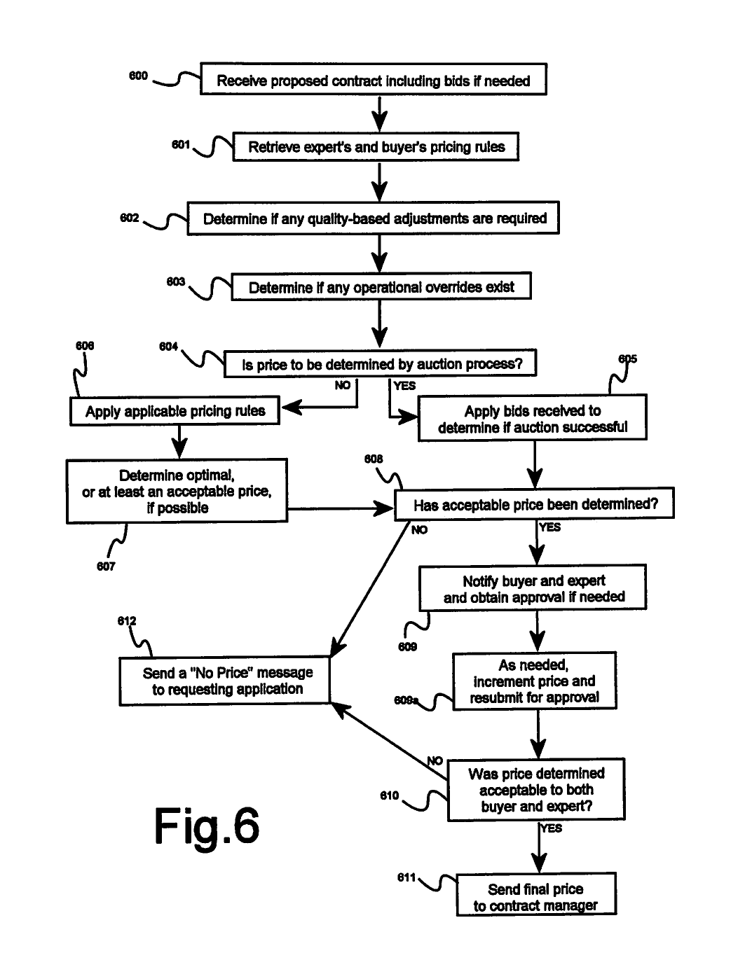

Pricing module 210 is a software application or module (with all of the flexible architectural possibilities discussed earlier) that manages the process of determining prices for expert services contracts or the work items of which they are comprised. The inventor has envisioned a wide range of pricing arrangements that may be advantageously pursued in one or more expert service contracts established and fulfilled through expertise marketplace 100. In some cases, fixed prices are used for a given contract or a group of contracts. For example, an online news site might offer fixed price contracts for editing, by qualified editors, of news items prior to their publication. Prices for such a set of contracts might be in terms of a fixed fee per hundred words edited, a fixed fee per article edited, or a fixed hourly rate for editing services. It is anticipated, though, that while fixed-price contracts (and typically very low-priced contracts) may be typical in contracts relating to commodity services, it will often be desirable to use more flexible pricing schemes when conducting an expertise marketplace 100. While there is undoubtedly an ample supply of experts around the world who are willing to work for low fixed rates (all the more so in our time of protracted economic distress), it will almost always be true that, when supply of highly-qualified experts 120 is limited enough, a truly competitive marketplace will emerge and more sophisticated pricing mechanisms will be needed. But more than simple supply and demand considerations are at work when considering true expert marketplaces 100. Commodity services (such as reviewing optical character recognition output or assessing adequacy of scanned documents for readability) are characterized in that it is usually difficult to differentiate one work item from another; when all work looks the same and requires some minimum of commonly available skills, fixed prices—and indeed low prices—make sense. But when each work item may require a unique or fairly uncommon set of specific skills, many of them advanced, and particularly when different work items may have different intrinsic values and different requirements for timeliness, more robust pricing means will likely improve the chances of a real market developing. For example, consider legal document review. In some cases, such as routine mortgage documents, it may seem trivial and suitable for a low-skilled workforce working for fixed, low prices (although even this is arguable, given the recent unexpected consequences of highly-routinized mortgage document reviews at large banks!). But if there are thousands of deal-related documents that need to be reviewed for a high-profile securities fraud case, it is likely that a wide variety of skills (none of them trivial) will be required to adequately perform the work, and it is also likely that a wide range of timeliness requirements, second and third level review requirements, and intrinsic values per work item, will be involved. In such a situation, it would be desirable for an expertise marketplace 100 to be able to provide a rich enough range of pricing options to enable buyers and sellers to meet and to conduct productive transactions. If a sound market is in place, high-end experts may be willing to trade high hourly rates for a results-oriented price scheme that also allows them to exercise considerable personal autonomy; only if a sufficient number of bona fide experts find the economics attractive will any expertise marketplace 100 be able to operate. A detailed discussion of a dynamic pricing process is provided in reference to FIG. 6. It should be appreciated by one having ordinary skill in the art of online marketplaces that prices will be influenced or set either by buyers, or by sellers, or often by both, with or without intervention by a market maker 103. Moreover, in some embodiments aggregators 102 set prices visible to buyers, and then either enforce a pricing scheme of their choice on experts 120, if they have enough market power to do so, or allow interactions between many experts 120 to determine selling prices of experts' labor (attempting nevertheless to ensure that adequate opportunity for profit by aggregator 102 exists). In such embodiments, in effect one side of a sale has a fixed price (in this case, the buyer's side), and aggregator 102 (or market maker 103) willingly takes on the risk of not getting low enough prices from experts 120 to make a profit, but also gains any upside if seller prices can be kept low enough (as is well understood in marketplaces generally, an entity acting as an aggregator 102 or market maker 103 generally operates with more complete, timely information than any single expert 120 or small group of experts 120 and, therefore, can take positive steps to ensure that prices are set in a way that minimizes their exposure to loss).

Correlation or optimization engine 211 is a software application or module (with all of the flexible architectural possibilities discussed earlier) that provides a specialized set of algorithms that are useful in several contexts within expertise marketplace 100. According to a preferred embodiment of the invention, correlation/optimization engine 211 comprises an optimization engine adapted to carry out a wide range of known and proprietary optimization routines, including but not limited to simple convex optimization routines, integer programming routines, and constraints based optimization routines. In addition, correlation/optimization engine 211 is adapted for reviewing large sets of data to determine underlying correlations that might escape a casual review of typical business process reports. For example, when a large set of experts have been associated with a common set of skills, such as forecasting, scheduling, and routing skills, correlation engine 211 will in some embodiments review actual performance data for the set to determine if one or more subsets exist that exhibit highly correlated behaviors. An exemplary pattern that might be uncovered in this way might be that one subset of experts are very consistent in their results in all of the skills being examined, while another subset of experts tend to be very consistent in routing and scheduling skills but actually quite inconsistent in forecasting skills (leaving aside, for purposes of this discussion, any issues of how skills are actually measured). A different kind of correlation might be that a certain subset of experts turns out to perform very well in their evenings, but very poorly in their mornings. Or, another subset of experts might perform very efficiently for a particular kind of work item only when the work comes from a participant in the insurance industry; the same subset might be much less efficient in performing the same kind of tasks in the banking industry. In some alternative embodiments, correlation functions and optimization functions might be distributed into separate components (such as a correlation engine and an optimization engine); in other alternative embodiments correlation and optimization functions are carried out directly by software modules that require the results, for instance pricing module 210, scheduling module 216, work and workflow management module 215, and skills assessment and management module 214. Correlation/optimization engine 211 is shown as a separate component in FIG. 2 in order to allow for clear description of its functions, and alternative arrangements in which correlation/optimization engine 211 is not provided separately should not be considered to be outside the scope of the invention as claimed.

An example of an optimization problem that would be handled by correlation engine 211 is the allocation of work to experts. While the actual management of work inventories and tracking of expert availability is (as discussed above) a responsibility of work and workflow management module 215, in a preferred embodiment work module 215 sends requests to correlation engine 211 when confronted with a high-dimensionality optimization problem. For example, if there is a small set of experts available in a particular moment who could handle call monitoring in English, and an English-speaking call requires monitoring, “normal” work routing would assign the call to either a longest-waiting or a most-skilled expert. If a certain expert were both the longest-waiting and the highest-skilled English agent, that expert would seem to be the obvious choice. But imagine that a forecast generated by scheduler 216 suggests that a high-value French call is likely to arrive in the next two minutes (or imagine that a French-speaking VIP caller is in a voice menu tree and can be expected to reach an agent in two minutes); additionally, assume that the highly-qualified English-speaking and longest-waiting expert is also the only French-speaking expert available, and there are several other less-optimal but still qualified English-speaking experts at hand. In such a situation, correlation engine 211 would likely return a result stating that the English call should go to one of the less-skilled agents so that the most-skilled agent would be available to handle the French-speaking VIP when that caller left the voice menu tree. It should be clear that many possible situations will occur in pricing, scheduling, and routing of work tasks and contracts that may require use of an correlation engine 211 with built-in optimization routines. While it is possible, according to the invention, to embed optimization routines within each of the likely modules that will require optimization (that is, skills assessment and management module 214, work and workflow management module 215, scheduler 216, and pricing engine 210), it will be common in various embodiments to have a separate module that performs these mathematical optimization tasks—which will be very similar mathematically even though dealing with different aspects of expertise marketplace 100—in a highly efficient way. Certainly showing correlation engine 211 as a separate component in FIG. 2 highlights the importance of optimization and correlation algorithms in implementing an efficient expertise marketplace 100, but because the functions could be carried out independently within the various specific functional modules of expertise marketplace 100, it should be noted that embodiments without a separately-implemented correlation engine 211 should not be assumed to fall outside the scope of the claimed invention.

Finally, configuration subsystem 212 comprises one or more configuration management software applications or modules (with all of the flexible architectural possibilities discussed earlier) that provide configuration services to the specialized functional modules. Configuration services includes, but is not limited to, services such as user management, specification of connection parameters to allow the various components of the system to interoperate, validation of newly-added data, and provision of notification of changes in underlying configuration data to all affected components. It will be appreciated by those having ordinary skill in the art of distributed systems design that there are many ways of providing a systematic configuration management capability for a complex distributed system, any of which may be used according to the invention without departing from its scope.

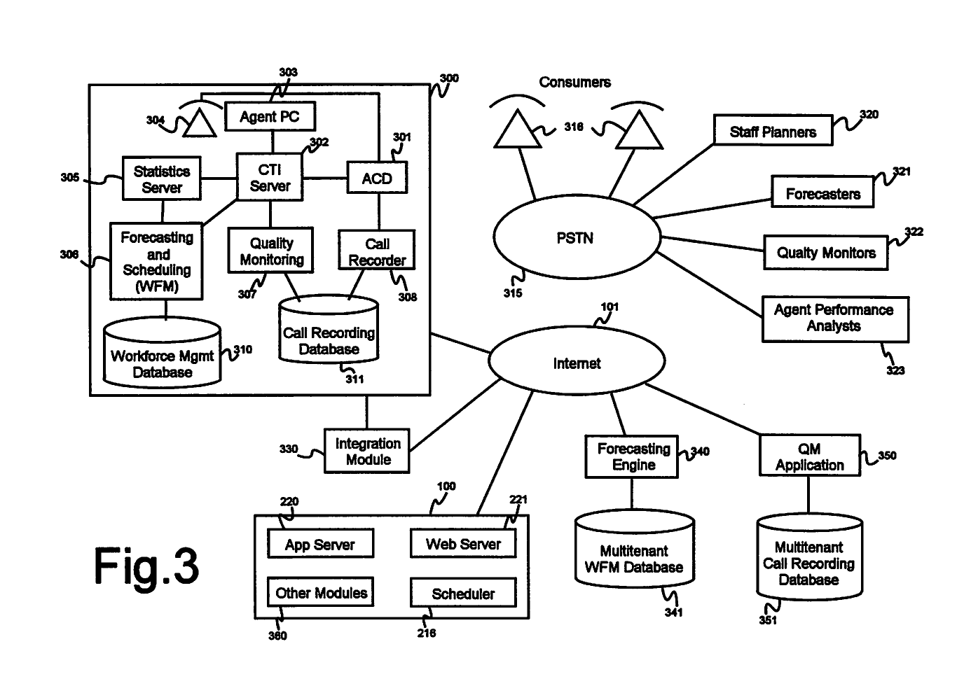

While FIG. 2 provides an overview of typical components present in embodiments of the invention, FIG. 3 illustrates a specific embodiment intended to provide a marketplace for workforce management and quality management service delivery for contact centers. As a preliminary matter, note that other modules 360 represents all of the modules illustrated within expertise marketplace 100 in FIG. 2, which are shown collectively as a single component to simplify FIG. 3; only scheduler 216 is shown separately because of its potential use as a call center workforce scheduler in the embodiment illustrated in FIG. 3. Furthermore, in FIG. 3 application server 220 and web server 221 are shown inside of expertise marketplace 100 instead of outside, as they were in FIG. 2. This is both to emphasize their use in conjunction with marketplace 100 in FIG. 3, and to provide an example of the wide variety of implementation options that are possible according to the invention. Also, for purposes of illustration FIG. 3 is limited to discussion of a call center 300, and does not illustrate additional customer interaction channels such as is common in many contact centers today. This choice is again merely for readability; nothing in the description provided herein should be taken as being limited to voice-based call centers, but is applicable to any customer interaction contact centers, and indeed these serve primarily as an exemplary embodiment of how real-world expertise marketplaces 100 envisioned by the inventor are likely to operate. Regardless of vertical or market or functional focus, any expertise marketplace 100 is likely to have integration challenges similar to those addressed by the embodiment illustrated in FIG. 3.

Call center 300 is a typical voice-based call center. Consumers call in to call center 300 (or are called by call center 300) using telephones 316, which typically are plain old telephone system (POTS) phones terminating in a public switched telephone network (PSTN) 315, but may be voice over Internet protocol (VOIP) phones (which could actually terminate in Internet 101). Calls arriving or originating at call center 300 are usually terminated at automated call distributor (ACD) 301, which delivers them to an agent phone 304, where an agent (customer service representative) serves them using agent PC 303. In many call centers 300, computer telephony integration (CTI) server 302 acts as a data communications hub for the center, integrating directly to ACD 301 via a CTI link. CTI Server 302 typically provides event notifications (with associated data) concerning telephony events to agent PC 303, which allows agents to receive a “screen pop” (a screen populated with data relevant to the calling or called customer is popped up on Agent PC 303; usually a phone number corresponding to customer phone 316 is used to identify the calling customer and to generate the screen pop). In many modern call centers, a statistics server 305 such as the well-known StatServer from Genesys Telecommunications Laboratories is connected to and receives events from CTI Server 302; statistics server 305 calculates and delivers real time and historical statistics pertaining to the operation of call center 300 to various client applications. Among these typically is a forecasting and scheduling server 306 (or set of servers), which together with a real-time schedule adherence server comprise a typical workforce management (WFM) application (forecasting and scheduling server 306 is often referred to simply as WFM Server 306). WFM applications are extremely data intensive, and it is quite common for a separate WFM database 310 to be used in call centers 300. Typically, raw statistics from statistics server 305 are stored directly in WFM database 310, so as to build up a history of statistical performance of call center 300. This history is then used by WFM server 306 to generate a forecast of upcoming call arrival rates (typically done on a per-call-type basis, for example by generating separate service, sales, and collections forecasts). Forecasts are also typically stored in WFM database 310. WFM server 306 also stores applicable work rules in WFM database 310, and information about individual agents' skills and performance on customer calls can be stored there as well (although often skills data is stored in a separate configuration database, not shown). In most call centers, all or a statistical sampling of calls is recorded automatically by call recorder 308; recordings are usually stored in a compressed format, with highly-optimized indexes for rapid access, in a call recording database 311. Most call centers have a staff group of quality monitoring professionals, who typically use a quality monitoring application 307, which in turn uses data from CTI Server 302 and from call recording database 311 (and, although the connection is not shown, often statistical data from statistics server 305) to assist these professionals in actively monitoring and assessing the quality of agent interactions with customers. It will be appreciated, of course, that the simplified call center 300 shown in FIG. 3 is merely illustrative, and that there are many alternative configurations and many additional components that might be present in any real-world call center 300).

As mentioned earlier, in many cases smaller call centers 300 are not adequately staffed with specialized professionals commonly found in larger call centers 300. Among these specialized professionals are staff planners 320 (who make long-range hiring plans and who put together and administer monthly or weekly work schedules using WFM applications 306), forecasters 321 (specialists in forecasting call arrival rates using historical data and a variety of specialized tools also typically found in WFM applications 306), quality monitors 322 (professionals specialized in using QM systems 307 and call recordings in call recording databases 311 to assess call quality and trends therein), and agent performance analysts 323 (professionals, often with an operations research or human resources background, who specialize in analyzing performance of call center agents using statistical data from statistics server 305 and common business intelligence tools). Moreover, even for larger call centers 300 these professionals, if kept on staff full time, are limited to learning from data generated by the particular call center 300, and may be limited in their ability to be exposed to a wide range of operational situations. For both of these reasons, it is advantageous for expertise marketplace 100 to enable call centers 300 to utilize external experts in these areas by making available an efficient market for these experts. However, when considering delivering expertise of the types just describe via an open marketplace, several significant challenges, which heretofore have prohibited the emergence of real expertise marketplaces 100, are immediately apparent.

First, external experts generally require access to the same systems and data that internal (staff) experts require. In some cases this can be provided in a quite straightforward fashion; for example, for legal document review experts, documents can be distributed quite readily using email or a shared file system, and only readily solvable security and confidentiality issues present themselves. But with call centers 300, external experts will typically require real-time or at least full and accurate access to call center data. Considering that internal staff experts are generally working directly with one or more of the source systems shown in FIG. 3, it may be desirable to allow the same access to external experts. However two problems arise: first, it is generally not trivial from a security point of view to allow direct access to systems that contain sensitive consumer data to outside persons (and this problem, while generally solvable, is most severe in small call centers with inadequate information technology systems—and these are precisely the prime target market for expertise marketplace 100); and second, external experts rarely work for any single call center 300, and would thus have to have access to each separate call center's systems and would have to know how to use each of the call center's systems, which often are provided by different technology vendors. These problems make it desirable for expertise marketplace 100 to provide a standard set of tools and datasets to its expert population in various areas of expertise. For example, forecasting engine 340 could be provided to forecasters 321, who would be able to work for many different call centers 300 without having to connect to, and remain proficient in, the systems of each. In another example, quality monitoring experts 322 could be provided with a dedicated quality monitoring application 350 that is independent of any single call center 300, again so that the experts would not need to connect to or be familiar with each of the call centers' quality monitoring systems 307.

A further situation in which it may be advantageous to use an expertise marketplace 100 according to the invention is when a particular kind of expert task is only rarely necessary to be performed, but then in some cases may need to be performed many times. For example, when major commercial litigation occurs, often there is a sudden need for rapid and expert review of very large numbers of documents (sometimes millions of pages), where immediately prior to litigation the parties to the litigation may have had no need whatsoever of large scale expert document reviewing. Similarly, in some cases large companies are required to perform extensive audits of, for example, several years' of customer communications (for instance, when compliance audits for financial services firms are initiated in response to an issue) might need to be listened to and audited for compliance with, for example, financial disclosure regulations. In cases such as these, while it may be cost-effective (and legally mandated) for the affected company to retain materials that might be reviewed or audited, it is generally not cost effective for even very large companies to maintain large expert staffs for use in only rare, potentially unpredictable circumstances. In such scenarios, it will be advantageous for companies faced with such sudden demand for large scale expert services to make use of expertise marketplace 100 to rapidly scale up their expert populations to accomplish the required tasks—and to rapidly downsize the same expert population once the task set is completed. This tendency to use expertise marketplace 100 is made even more compelling by the fact that, oftentimes, such unpredictable and large needs for expert services may be accompanied by stringent timeliness and quality requirements, placing additional demands on expertise marketplace 100 (that is, it won't generally be sufficient just to provide a large number of generic experts on demand, but to provide the optimal mix of experts for the particular tasks to be accomplished and to ensure that the tasks are accomplished with required quality levels.

In both exemplary cases just described (and others like it that typically arise incident to creation of expertise marketplaces 100 according to the invention), one need is to have a centralized storage system for specialist data (it would typically be prohibitively expensive to fully duplicate each call center's 300 data systems, and to maintain a separate database for each call center 300 client of expertise marketplace 100). Accordingly, considering the two examples, it will typically be necessary to provide a multitenant WFM database 341 to support external forecasters 321, staff planners 320, and agent performance analysts 323, and to provide a multitenant call recording database 351 to support quality monitors 322 who use an external QM application 350 provided by expertise marketplace 100. “Multitenant” here has the meaning it generally is understood to have in the art of cloud-based services design—many separate business or legal entities (“tenants”) use a shared infrastructure element or set of elements, with the data of each being protected from inadvertent access or modification by any other tenant. In essence, multitenant systems provide strong security capabilities that ensure that only authorized users ever access any tenant's data, and that provide positive means to guarantee and to verify this, including comprehensive auditing capabilities. Use of secure multitenant architectures allows a provider of an expertise marketplace 100 to achieve significant economies of scale (it is much cheaper to share components than to have a separate copy for each potentially quite small tenant) while providing needed assurances of data integrity, confidentiality, and stability. It will be appreciated by one having ordinary skill in the art of cloud-based systems used by large numbers of clients that, while multitenancy is often a key goal, it is also possible to operate cloud-based services using multiple instance of a single standardized platform. Such multi-instance deployments are common when clients are larger companies and have stringent data security requirements, for example. The emergence of virtualization technologies over the last few years has made it potentially cost-effective to use simpler multi-instance architectures that take advantage of large numbers of virtual machines running on general-purpose machines, rather than to use much more complex multitenant software solutions. It is possible to use either multitenant or multi-instance implementations of any of the components described as “multitenant” herein, without departing from the scope of the invention.

In order for expertise marketplace 100 to provide centralized specialist applications and the necessary underlying multitenant data storage systems needed for each of them (keeping in mind that databases 341 and 351 could be implemented on a shared infrastructure), a means of integrating them with data systems maintained in each call center 300 is normally required. Integration module 330, for example, is a software module or application whose role is to provide real-time or near real-time integration between, for example, workforce management database 310 and multitenant WFM database 341, or between call recording database 311 and multitenant call recording database 351. There may of course be any number of other specialist expert applications provided by expertise marketplace, each of which must typically be integrated to a source system in call centers 300, so that data may be passed to and from each system (external, multitenant and internal, single tenant). While in some embodiments there may be one or even more than one integration module 330 per expert application, in other embodiments a single comprehensive integration module 330 may provide a means for secure data exchange between a plurality of external multitenant expert applications and the corresponding internal expert applications.

FIG. 4 is a process flow diagram illustrating an exemplary method for establishing and managing a pool of experts, according to an embodiment of the invention. Clearly, in order for an efficient market to exist, an adequate inventory of experts in each category to be served must be developed and maintained by expertise marketplace 100. Moreover, the quality of services provided by these experts will typically be monitored in order to ensure that only truly qualified experts are able to bid for and win contracts to deliver services; if quality is not maintained to the satisfaction of buyers, they will surely leave and expertise marketplace 100 will not achieve critical mass. Clearly, one aspect of achieving success in developing and growing an expertise marketplace 100 is to carefully identify not only what market segments are likely to need such a marketplace, but also what classes of experts will be needed to meet the needs of those segments (and what specific skills are needed by experts of these classes!). Accordingly, in a first step 400, expertise marketplace establishes and promulgates expert classifications appropriate to any markets it desires to serve. For instance, one classification might be “advanced staff planner for contact centers”, and another “forecaster—call center”. Clearly there will be a very large number of potential classifications, and many different approaches might be taken by an expertise marketplace 100 in classifying types of experts and identifying markets to serve. In some cases (step 401), potential buyers will proactively approach an expertise marketplace 100 with specific, perhaps atypical, expertise needs. For instance, a law firm might approach an expertise marketplace 100 and request a dozen experienced forensic scientists to review a large volume of time-critical forensic data in a complex criminal defense case. Or, in response to an event in a country that does not normally receive heavy journalistic coverage in developed nations, a global news agency might seem a number of editors and translators who are proficient in, for example, Malayalam (the language of Kerala State in India, which has a large number of native speakers but is little known in the West). Then, based on classifications established in step 400 and requests made in step 401, expertise marketplace 100 may optionally post advertisements and other requests for experts. “Other requests” could refer, for example, to direct email contacts with a number of experts identified from a professional networking system such as is operated by LinkedIn, Inc. After these initial steps, presumably a number of prospective experts will respond and approach expertise network 100. In step 403, these prospective experts would be registered (typically but not necessarily using recruitment and registration management application 213). Then, in step 404, expertise marketplace 100 will typically validate prospective experts' eligibility for participation in the marketplace 100, or for a particular expertise need. Thus, certain skill-related checks could be made (“does the expert have a valid masters degree in electrical engineering?”), as well as other checks pertaining to relevant attributes such as creditworthiness, criminal records, certification or licensure to perform specific expert tasks (for example, checking to see if a document reviewer is actually admitted to the bar in any jurisdiction). Experts who meet any basic requirement checked in step 404, may then be asked to provide a more or less thorough self-classification (how detailed such a self-classification is may of course vary between instances of expertise marketplace 100, or between different classifications of experts). For instance, it may not be possible or desirable for an automated or manual check to be made by expertise marketplace 100 to see whether a prospective expert has actually received a four-year degree, even though it is stated as a requirement (not all requirements will require full checking, as for instance when it is a desirable condition but not a legally binding one, such as might occur for medical or legal professionals). Classification data received in step 405 can be quite rich or very basic, depending on need. For instance, it is likely that a full professional profile will be desired for expert consultants, listing significant employment and professional credentials and accomplishments, but it may not be desirable to go beyond a simple check for language proficiencies when translation or editing is not a core activity for a given expert classification). In some embodiments, automated profile generation may be conducted by gathering data from publically available sources such as search engines and professional networks such as LinkedIn™ (of course, mining networks such as LinkedIn™ can also identify experts to whom invitations might be sent in step 402).

In some embodiments of the invention, automated skills assessment is used to augment or replace expert self-assessment in step 406. Normally, automated skills assessment is performed using tests that are administered to subject experts, which of course is well understood in the art (there being many forms of computer-based training and testing available in the art). Testing is normally executed using skills assessment and management module 214, although other arrangements can be made. In some cases, testing is administered using multiple-choice questions, although more complex forms of testing are certainly envisioned by the inventor. For example, in a preferred embodiment prospective experts are asked to perform a task related to that which they are proposing to do on behalf of clients, such as translating a text sample, assessing the quality of a set of sample service calls (for quality monitoring experts), and so forth. One or more means of automated scoring of these “practical factors” can be used to assign an initial skill level to experts. For example, if the skill to be demonstrated is translation, a series of approved translations would already be available within skills assessment module 214, and a distance metric such as the well understood Levinson distance is used to measure objectively either an average “distance” from the test sample to the plurality of approved translations, or the minimum “distance” from the test sample to each of the approved translations. In other embodiments quality would be assessed by evaluating whether a maximum distance from a test sample and a plurality of approved translations exceeded some predetermined threshold. Similarly, for quality monitoring, for a standard set of test interactions that can be used for multiple candidates (unless there is some concern that candidates are able to share information about testing, which generally is unlikely), a set of approved quality assurance scores including particular points or issues observed, could be used as a baseline of what satisfactory quality assessments should look like, and compared against the test assessments performed by a prospective expert. Finally and optionally, experts that have been approved, registered, and that have been assigned skills (either through self-assessment or testing) would, in step 407, be permitted to enter pricing rules under which they propose to operate. A wide variety of pricing rules may be used, according to the invention, including for example fixed prices for different periods of the day (and for different days of the week, for holidays, and so forth), quality-dependent pricing (which would tend to be higher for those experts that achieve high quality ratings, but potentially lower for those who don't—although there may be a minimum standard rate which experts scoring low in quality would receive, with the “compensation” for poor quality scores being the lack of ready work, since higher-scoring experts would tend to get more work). Some experts may prefer to sell their services through an auction process, optionally with minimum or reserve prices established. Others still may be willing to work on a per-contract pricing basis, waiting for work to be offered and then considering the price at which it is offered (this approach would work well, for example, if buyers chose to use a reverse auction to bid for services, allowing experts to agree or not to work for a price they are willing to pay). It is anticipated that, as expertise marketplace 100 develops to a point where many contracts are agreed and fulfilled daily, a wide range of pricing rules will be adopted by both experts and buyers, each pursuing its own specific business needs.

FIG. 5 is a process flow diagram illustrating method for establishing work contracts, according to an embodiment of the invention. The process is carried out in contracts manager module 217, or its equivalent. In a first step 500, a plurality of prospective buyers of expert services are registered and validated. As with experts themselves, validation can take several forms, including but not limited to credit checks, verification of payment information (as is commonly done with ecommerce applications), background checks for criminal or other risk issues, and the like. In some embodiments, buyers are registered provisionally until they have completed enough transactions to establish a suitably strong risk rating; while in a provisional status, buyers may in some cases only be allowed to use fixed price or other low risk contract structures. Once buyers are registered and validated, they may in step 501 send requests to expert marketplace 100 to purchase expert services of one or more categories. Optionally, in step 502, buyers may provide pricing parameters to be used in creating contracts. As in the case of experts, there are many variations of pricing parameters that may be used by buyers. Among these are fixed price bids, fixed price for guaranteed quality bids, prices that may vary based on actual quality, prices that depend on the quantity of work to be delivered by a given service provider or set of service providers, prices that may depend not only on quality but also on timeliness of expert work accomplished, or even reverse auctions (when a buyer says “I am willing to pay up to $X per unit of work, but want to pay as little as possible”, and then experts bid down to try to win the business). Similarly, in step 503 buyers may optionally enter time parameters, generally but not necessarily of a form such as “I want X units of expert work of type Y done between 0900 and 1200 tomorrow, and I am willing to pay $Z per unit for the work, as long as quality meets the standards I have set”. In some cases, buyers may stipulate that a certain minimum (or maximum, or exact) amount of work must be accomplished by a certain time in the future. Buyers may be permitted, in some embodiments, to specify financial incentives and penalties for time and quality-based attributes of expert work that they purchase. For example, a buyer might specify that she will pay $10 per unit of work, unless the quality metric (however defined) falls below some level, at which point she will pay only $7.50 per unit; in such cases, a minimum quality score will often also be set, below which work will not be paid for at all. Once a buyer has entered various parameters governing how work is to be managed and paid for, in step 504 expert marketplace 100 determines which experts are or might be made available to fulfill the demand thus created. Experts are generally selected based on a combination of factors, including whether they have the required skills to perform the work, whether they are available or have indicated they will make themselves available on request during the time period in question (if work is tied to a particular time period), whether they satisfy any task-specific work rules established by a buyer (for instance, a buyer could set up a rule requiring that no experts from a certain aggregator 240 can be used to provide a given service), and so forth. Note that it will commonly be the case that multiple experts will be identified in step 504. For example, when a reverse auction is to be conducted, there may be a large set of identified prospective experts, the set comprising the potential bidder population in a reverse auction.

In step 505, contract management application 217 determines a price or pricing method to be used, if necessary. While more detail on price determination will be provided in the discussion of FIG. 6 below, several key points are usefully made here. First, in some cases no pricing computations are needed, as for example when a buyer says (in step 502), “I will pay this set price for work under this contract, and no other price”. In such a case, only experts who have made themselves available to work at that price (and who have the requisite skills, etc.) will be selected for consideration in step 504. In other cases, a computation will be needed, and the computation will be expected to yield a single price (or a statement that there is no price that will work for the proposed contract). This would occur, for example, if an auction or reverse auction is selected by the seller (auction) or buyer (reverse auction)—in step 505 the auction is carried out, with the result that either a price is set that meets established parameters of both buyer and seller, or the auction is reported as a failure. But in some cases, only a pricing rule, or a set of pricing rules, will issue from step 505. This would happen, for example, when a buyer states that she will pay between $X and $Y per unit of work, depending on objective measured quality metrics, and when sellers willing to work under such a scheme are identified. In this example, no actual final price is established, since the price that will be paid will be determined by the pricing rules selected at the time (or after) any contracted services are delivered. Moreover, in some cases pricing rules may be established which have a time-delayed resolution. For example, a seller might state that she will pay $X per unit of work, but will augment that price with a bonus of $Y if at least some specific amount of work is accomplished in a given month. In such a case, the final price will not be known until the end of a month (or until the minimum bonus amount of work is completed, which could occur earlier than the end of the month). Thus it should be clear that the inventor envisions a rich range of prices and pricing rules resulting from the application of step 505, the examples just given being just that—examples.

Once contract management module 217 has assembled all of the information elements gathered or computed in steps 502 through 505, in step 506 a proposed expert services contract is created and submitted to prospective buyers and sellers. Proposed contracts would identify what is to be done, for whom and by whom, when, for what price, and with what qualitative or quantitative guarantees. In some embodiments, buyers and sellers would also be provided with background information on the other prospective contracting parties, so that a buyer could for example review the track record and profile of a proposed expert before agreeing to do business with the expert. Contracts could be delivered as “drafts”, with buyers and sellers provided with user interface means to modify elements of the contract, for example if a seller wanted to adjust a bonus level based on an attribute of a proposed service provider. Accordingly, in step 507, contract management module 217 receives approvals or changes from prospective buyers and sellers. In some embodiments, buyers and sellers are required to positively approve a proposed contract before it becomes binding, and any changes made by one prospective party must be reviewed and approved by the other party (or parties). In other embodiments, automated approvals are allowed, so that a draft contract provided in step 506 will be automatically approved in step 507 if it satisfies certain limits established by the approving party. Even when this is true, however, in most embodiments a positive statement of acceptance, even if delivered solely as an automated electronic notification, is required before a contract becomes binding within expertise marketplace 100. In step 508 contract management module 217 checks to see if all prospective parties have approved a contract proposed in step 506. If one or more parties declines to approve or proposes changes in step 507, the process moves to step 511, where changes are made based on input from prospective parties, and the process loops back to step 506. In most embodiments limits are established to prevent unduly repetitive or indefinite looping through steps 506-508. Such limits may be simple, such as “don't loop more than three times before simply rejecting a contract as unworkable”, but could be quite complex, for instance defining complex rules to determine whether two or more parties are too far apart even on a first iteration to even attempt an iteration (essentially, if such a rule is satisfied in step 508, the contract is rejected as unworkable directly, without iteration). If a contract is approved by all parties, in step 510 contracts management module 217 issues a completed (and binding) contract and activates any appropriate workflows based on the contract. Normally each party will receive an automated notification that a contract has been formed, the notification providing all of the parameters of the contract; additionally, the issued contract is entered into data storage subsystem 200 for persistent storage.

FIG. 5 illustrates an exemplary process in which buyers drive the process of creating binding service contracts. It is only illustrative, of course, and other approaches are possible according to the invention. For example, if an expert with a superb quality reputation who is in real demand desires, the expert could offer to provide services to the highest bidder for certain key time periods. In such a case, the expert would submit a request in a step analogous to step 501 and would establish selling and scheduling parameters in steps 502 and 503; contracts manager 217 would determine potential buyers (bidders) in step 504, and then in step 504 submit all the data to pricing module 210, which will then conduct an auction to determine which buyer, if any, successfully bids for the expert's services.

In order to more fully illustrate a range of pricing mechanisms according to various embodiments of the invention, FIG. 6 provides a process flow diagram illustrating a method for implementing a dynamic pricing model for an expertise marketplace, according to an embodiment of the invention. In step 600, corresponding roughly or at least approximately contemporaneous to step 505, pricing module 210 receives a proposed contract, including bids and specific pricing parameters from prospective parties, if appropriate (for example, if a buyer has specified a reverse auction, then a strike or target price is sent to define the price below which a contract can be formed; in some cases opening bids from prospective experts will also be provided). Then, in step 601, pricing module 210 optionally retrieves any general pricing rules established by any of the prospective parties of the proposed contract, whether experts or buyers. In step 602, pricing manager 210 determines if any quality-based adjustments are required, and in step 603 it determines if any operational overrides exist. An operational override would be a rule that would state that, for example, no more than 10% of a given buyer's work can be accomplished by any single expert (a rule such as this might be stipulated to ensure that a buyer with a large work inventory got the benefit of the skills of many experts, so the buyer could evaluate results across a wide range of experts and expertise levels). “Override” means a rule that, if triggered, will override or supersede any pricing model being used. I step 604, a check is made to determine if price is to be determined by an auction.

If price is not to be based on an auction, then in step 606 applicable pricing rules are applied by pricing module 210 and, in step 607, an optimal (or at least an acceptable) price is determined. In some cases, pricing will be straightforward (a trivial example being fixed price contracts where the buyer simply states “This is what I will pay, take it or leave it”), but in many cases correlation engine 211 will be used to determine an optimal price. For example, in an embodiment price is determined using a correlation engine 211 to apply constraint-based or other optimization techniques to determine an optimal price that maximizes profits for a buyer or aggregator while guaranteeing a minimum aggregate quality level. It generally is easy to guarantee a minimum quality level, by allowing no experts who are likely to deliver services below that quality level, but guaranteeing a minimum aggregate quality level while maximizing profits is a textbook example of an operational research optimization problem. In another embodiment, correlation engine 211 is used in conjunction with pricing manager 210 to manage prices using a yield management approach similar to that used by airlines. Such a yield management approach will typically consider not only price and quality, but also schedule (see discussion pertaining to FIG. 7 for more on scheduling) and the balance of supply and demand. For example, a buyer may have a large quantity of work to be done, each item of which needs to be done within some narrow time window (e.g., monitoring phone calls for quality management), and the buyer naturally desires to minimize price paid for the services, while maintaining a good overall quality level. Using a yield management approach, it may be desirable to keep quality high during off-peak periods, when expert prices might be low due to oversupply, while during peak periods a wider range of quality might be acceptable (taking advantage of “credit” in aggregate quality earned during off-peak periods), with prices generally being higher (because of possible scarcity of experts). Since scarcity of experts can often be mitigated by tapping additional sources of expert services, but these additional sources might not be as proficient because they don't perform as much work for the particular buyer, allowing quality to be more variable during peak periods may be an effective approach to mitigating any natural price increases during supply-constrained peak periods. Clearly by dynamically manipulating price, quantity, quality, and schedule, it should be possible for correlation engine 211 and pricing manager 210 to manage a wide range of optimization strategies, all the more effectively as the size of expertise marketplace 100 grows. For example, while in the examples just discussed the goal was to minimize price while maintaining some minimum level of quality, a different buyer might prefer to maximize quality while not allowing profitability to drop below some critical level. And of course it will often be the case that optimization strategies will be varied for different time periods or market segments. For example, a quality monitoring program for a large credit card contact center might require high quality regardless of cost for the monitoring of calls involving their VIP clients, while requiring a profit maximization approach for commodity segments, and an approach which optimizes price and quality for mid-range clients. It should be appreciated that there any number of optimization strategies that might be selected by different buyers and different experts (or aggregators), and it is a key object of the present invention to utilize correlation engine 211 in conjunction with pricing manager 210 and scheduler 216 to enable a dynamic expertise marketplace 100 where various classes of buyers and sellers can compete in an efficient way, and where an overall optimum economic benefit might be achieved (by allowing each participant to pursue their own optima, and performing global optimization across the marketplace 100, for instance by taking one large buyer's optimization strategies into account when determining a best fit for a particular expert's services). Also, it will often be the case that price will need to be determined while taking into account the quantity of services that are available for a given price—if a very profitable price is available, but only a portion of the available work can be delivered at that price because of a shortage of experts willing to work at that price, then the price may or may not be acceptable depending on the parameters established by the buyer. In some cases doing some work profitably now, and deferring the balance of work until a next opportunity to get it done inexpensively will be a good strategy; in other cases the work may be mandatory and a higher price will have to be paid to get it all accomplished by a required deadline.

Once pricing manager 210, potentially using correlation engine 211, has determined price in step 607, in step 608 a check is made to determine if an acceptable price has been determined. Similarly, if an auction is required in step 604, then in step 605 bids are applied and an auction is conducted by pricing manager 210, and then in step 608 a check is made as to whether an acceptable price has been determined. Regardless of how the process gets to step 608, if an acceptable price was not found then, in step 612, the application that requested a price determination is notified via a “No Price” message, which typically includes attributes that describe why no price was found (for instance, “Could not find an expert willing to meet buyer's fixed price”). Typically the application notified is contract manager 217, although it need not be so. In some cases, when work is assigned dynamically based on instantaneous supply and demand to a population of preapproved experts, and when price may be determined at least in part based on rules that depend on real-time circumstances, there may be occasions when work and workflow management module 215 tasks pricing manager 211 with determining what are in effect “spot prices”, and in these cases pricing manager 210 may need to send a “No Price” message to work and workflow management module 215.

If pricing manager 210 was successful in finding an appropriate price, then in step 609 buyers and sellers may be notified and approval of the proposed price obtained if necessary (although in many cases this step may actually be carried out by contracts manager 211 in step 506). Optionally prices may be incrementally adjusted in step 609a and resubmitted for approval and, in step 610, a check is made to determine whether an price acceptable to at least one buyer and seller was found; if not, step 612 occurs and a “No Price” message is sent as before. If a satisfactory price was found, then in step 611 the final price is sent to contract manager 211 or to any other application (such as work and workflow management module 215) that may require the price information. In many cases, additional information will be provided beyond the price itself, including but not limited to the identities of buyers and sellers for whom the price has been validated, or who have explicitly approved the price.

FIG. 7 is a process flow diagram illustrating a scheduling availability of experts and delivery of work suitable for execution by the experts, according to an embodiment of the invention. According to the embodiment, expert marketplace 100 actively manages expert availability and work, which can be advantageous for both experts and buyers, since it will tend to make expert marketplace 100 a more efficient market, enabling buyers and sellers of expert services to more accurately predict what their costs will be in the future. In a first step 700, scheduler 216 generates a list of all open work contracts, and periodically updates that list. As noted previously, contracts will generally vary widely and some may include specific time constraints while others are open-ended. The former can be classed as time-constrained or sometimes as synchronous contracts (“synchronous” refers here to contracts where some work task must be accomplished essentially synchronously with some underlying event, such as monitoring a call while it is ongoing or within five minutes of its completion), and the latter can be usefully classified as “backlog” work. One of the challenges to be overcome through use of scheduler 216 is to ensure that all synchronous or time-constrained work is accomplished within required time limits (or as closely as possible), while also ensuring that backlog work gets done. It is a common problem that all of the urgent work gets addressed while backlog levels continually increase, being reduced only when items are removed for staleness. Finding an optimal balance between maintaining a healthy backlog and meeting time constraints presents yet another complex optimization problem that embodiments of the invention address, and often correlation engine 211 will be used in conjunction with scheduler 216 to solve these problems (or at least to find an optimal approach to solving them).

In step 701, scheduler 216 determines which open contracts have schedule constraints (that is, are synchronous or time-constrained), and in step 702 a forecast of demand for work of different types for a series of time periods (typically 15-minute intervals, although any intervals may be used for forecasting and scheduling according to the invention). Generally it will be necessary to develop a forecast for each distinct type or class of work, although according to the invention these may be combined as desired, which may be effective when for example several types of work prove to have closely related characteristics. In the art of call center management, a very well-developed art of forecasting future call volumes exists, and in some cases (particularly those involving monitoring calls into call centers) it may be possible to use existing forecasts from a client call center instead of developing separate forecasts in expertise marketplace 100. In other cases, experts may use scheduler 216 to provide forecasting services on behalf of call or contact centers. Forecasting for a variety of work types spread across many buyers will generally be quite different from call center forecasting, however, as less of the work (demand) to be forecast is outside of the control of expertise marketplace 100 (that is, when forecasting call center traffic one does not know why callers are calling and cannot control when they call, and forecasters therefore must use historical data to extrapolate what future volumes are likely to be; in a marketplace, significant amounts of demand are open to being rearranged in time, and so uncontrollable demand makes up a smaller amount of the aggregate demand to be forecast). In some instances, demand constraints may be flexible, and may even be tied to price. For example, a buyer could set a price and request that a certain amount of work be done within a certain period, but also set a reduced price they would be willing to pay for work that is done outside the optimum period. In this example, expertise marketplace 100 would of course try to forecast all of that work into the optimally-priced time period, but might choose to defer some of the demand despite the impact on price, in order to create a smoother demand curve (that is, one that doesn't have dramatic changes that make forecasting and scheduling difficult). Because of the large number of variables (different work types, buyers, schedule constraints, price constraints, quality constraints, etc. etc.), correlation engine 211 will often be used by scheduler 216 to help determine an optimum demand forecast (and indeed an optimized schedule as well).

Once constrained work has been laid into a forecast for each general work type, in step 703 scheduler 216 generates a first-cut allocation of unconstrained (backlog) work to each of the schedule periods, based on expectations concerning likely overall supply of experts (of various types). Because scheduler 216 can actually set supply, within limits, it should generally be able to establish a coarse schedule in steps 702-703 that satisfies known constraints and includes enough backlog work to keep the backlog from expanding out of control, and that should be more or less consistent with the likely levels of supply for the affected periods. Then, in step 704, scheduler receives (either directly from experts 120 or more likely from data storage subsystem 200) work schedules and work rules from experts. These schedules and rules are typically updated periodically by experts, and in some embodiments scheduler 216 proactively requests updates from experts in an effort to keep work schedules and work rules accurate. Not all experts will submit work schedules or specify work rules, however; usually at least a percentage of experts working at any given time will be doing so in an ad hoc fashion. For instance, an expert may see that there is a surplus of quality monitoring work to be done, and that the rates being paid are high, so she decides to work now even though she had planned to work on a different project. Moreover, aggregators 240 may operate in a manner that is opaque to marketplace 100, supplying experts on demand (potentially in large numbers), and thus complicating the task of scheduler 216. However, over time patterns will emerge that can be leveraged by scheduler 216 (making use of correlation engine 211 as needed). For instance, if historically a certain aggregator provides 5% of total supply during business hours in the US, but very little or no supply during evenings, nights, and weekends, then that aggregator's likely contribution can be factored in by scheduler 216 in advance. As long as there is an adequate supply of ad hoc or easily added experts available at any given time, it should be possible for scheduler 216 to produce a forecast and a schedule that is close enough that any variations can be met by the population of ad hoc experts. Because prices may typically spike during periods of shortage, sending a signal to add supply, an expertise marketplace 100 operating according to the invention should, with sufficient “inventory” be able to provide a high degree of predictability to its clients on both the buy side and the sell side.

Once expert schedules and work rules are received, in step 705 experts with specific schedule constraints are allocated to various schedule periods, and in step 706 scheduler 216 iterates over a range of possible schedules to develop an overall schedule based on both expert availability (available supply) and on buyer's schedule constraints (available demand), taking into account (using correlation engine 211) price and quality constraints that may in turn depend on volume, schedule, or expert selections. Then in step 707 a proposed expert work schedule is published, and published schedules are kept up to date with changes as needed until the applicable time period has passed. For example, a schedule for an upcoming week could be published on a Thursday, and then feedback from both buyers and sellers could be taken into account by making modifications to the schedules for the various days, but obviously once Monday is in the past no further changes would be made. Once a published schedule, suitably amended, is “on record”, then as each scheduled time interval arrives, in step 708, scheduler 216 monitors actual availability of experts in each classification and the actual amount of work to be done (keeping in mind that some work is contingent on events and may not “arise” until during a schedule period in which it needs to be accomplished). In some cases, unplanned shortages of expert skills or excesses of work of certain classes could become apparent, and if needed, in step 709, marketplace 100 could publish requests for experts to perform unscheduled work. This is important because not all experts will be watching marketplace 100 all the time, and accordingly may depend on receiving notifications before making themselves available to marketplace 100 during peak periods (which of course is when their payoffs will be typically be maximized).

A key element of an effective scheme for optimizing a highly-dimensional process is feedback on performance. Accordingly, in step 710, as each schedule period expires, scheduler 216 will normally evaluate the actual accuracy of forecasts and adequacy of published schedules. Not only will issues that lead to inaccurate forecasts be detected by scrupulous adherence to a regimen of regular post-schedule evaluation, but also “fudge factors” can be calculated that can be applied in the future. For example, if messages requesting immediate expert assistance were sent to 50 experts in a certain field, and only 3 logged in to marketplace 100 in response, then if it later became apparent that there was a need for 6 additional experts in that area, scheduler 216 would “know” to send 100 requests out. Of course, the more data points that are obtained in this way, the more accurate such fudge factors will be, and in fact for commonly used factors it may be possible to develop a time-based function that predicts what the output of a given action will be (since some responses may differ depending on time of day or day of week, and so forth). Moreover, in step 711, expert marketplace may from time to time, based on reviews of actual performance as compared to forecasted performance, make modifications to algorithms used for creating forecasts and schedules in order to build in the effects of learning curves.

The skilled person will be aware of a range of possible modifications of the various embodiments described above. Accordingly, the present invention is defined by the claims and their equivalents.

1. A system for operating a marketplace for provision of services requiring skill, comprising:
a marketplace server computer attached to a network, the marketplace server comprising:
a registration software module adapted to enable a plurality of skilled workers to register as participants in the marketplace;
a worker skills management software module adapted to automatically measure at least an indicia of quality of work performed by a first skilled worker and to automatically update at least a skill attribute associated with the first skilled worker based on at least in part on the indicia of quality;
a contract management software module adapted to match a buyer and a seller based at least on a particular set of skilled workers' possessing a required skill and generates and publishes at least one binding contract based on the matching of a buyer and a seller;
a pricing software module adapted to compute a price for a unit of work the performance of which requires at least a specific skill managed by the worker skills management software module, the pricing computation comprising the steps of:
(a) retrieving a plurality of experts' and buyers' pricing rules;
(b) determining a plurality quality-based adjustments to one or more of the retrieved rules based at least on an indicia of quality of previous work performed by a specific skilled worker;
(c) applying the plurality of retrieved rules and the plurality of quality-based adjustments; and
(d) computing an optimal price; and
a correlation engine adapted to evaluate tuples relating to a set of skilled workers, each tuple comprising at least one of pricing rules, skill levels, and schedule constraints, in order thereby to select an optimal or near-optimal specific set of skilled workers to perform a specific set of work tasks.

2. The system of claim 1, further comprising a pricing software module deployed on at least one of the servers, wherein the pricing software module determines a price for a unit of work the performance of which requires at least one specific skill

3. The system of claim 1, wherein matching a buyer and a seller is further based on a price satisfying rules established by the buyer and the seller.

4. The system of claim 1, wherein upon registration a skilled worker establishes a set of rules specifying at least a price constraint for use in assigning work to the skilled worker.

5. The system of claim 4, further comprising a correlation engine software module deployed on at least one of the servers.

6. The system of claim 5, wherein the correlation engine is used to evaluate tuples relating to a set of skilled workers, each tuple comprising at least one of pricing rules, skill levels, and schedule constraints, in order thereby to select an optimal or near-optimal specific set of skilled workers to perform a specific set of work tasks.

7. The system of claim 1, wherein the skills management software module automatically determines a skill level of a skilled worker.

8. The system of claim 1, wherein the automatic determination of a skill level is carried out using the correlation engine.

9. The system of claim 1, wherein the price is a fixed bid price established by a prospective buyer of services.

10. The system of claim 1, wherein the price is determined by the pricing module using a formula dependent on at least one of service quality, service timing, and service quantity delivered by a specific plurality of skilled workers.

11. The system of claim 1, wherein a fixed price is established by a seller of services.

12. The system of claim 1, wherein the seller is an aggregator or a market maker.

13. The system of claim 12, wherein the aggregator or market maker purchases services from a plurality of skilled workers in order to aggregate those services and to sell them to the buyers.

14. The system of claim 1, wherein an identity of a seller is determined by the contract module based on at least a determination of a set of skilled workers capable of providing desired services while meeting one of price, schedule, or quality requirements from a buyer.

15. The system of claim 1, wherein a distribution of work to a plurality of skilled workers is determined by the contract module, wherein an optimal or near-optimal overall distribution of skilled work is achieved based on a plurality of work requirements and on evaluating a set of one or more quality, schedule, and price constraints.

16. The system of claim 15, further comprising an optimization engine that determines an optimal or near-optimal work distribution.

17. A method of online marketing of services, the method comprising the steps of:
(a) registering, using a registration software module deployed on a marketplace server computer coupled to a data network, a plurality of skilled workers;
(b) determining, using a worker skills management software module deployed on the marketplace, at least a skill level for each of the plurality of skilled workers;
(c) establishing, using a pricing software module deployed on the marketplace server, a price for a unit of work the performance of which requires at least one specific skill, wherein establishing a price comprises the steps of:
1) retrieving a plurality of experts' and buyers' pricing rules;
2) determining a plurality quality-based adjustments to one or more of the retrieved rules based at least on an indicia of quality of previous work performed by a specific skilled worker;
3) applying the plurality of retrieved rules and the plurality of quality-based adjustments; and
4) computing an optimal price;
(d) matching, using a contract management software module deployed on the marketplace server, a buyer and a skilled worker based at least on the skilled worker's possessing a required skill and on the price satisfying rules established for the buyer and for the skilled worker; and
(e) generating, using the contract management software module, and publishing a binding contract for delivery services to a specific buyer by a specific skilled worker;
(f) monitoring performance of the services specified by the binding contract to determine at least a quality score for the services performed; and
(g) further adjusting the contracted price based on the quality score.

18. The method of claim 17, further comprising the step of monitoring performance of the services specified by the binding contract to determine at least a quality score for the services performed.

19. The method of claim 18, further comprising adjusting the contracted price based on the quality score.
